(19) United States
(12) Patent Application Publication
(10) Pub. No.: US 2011/0062669 A1
(43) Pub. Date: Mar. 17, 2011

(54) METHOD FOR CAVITY SEALING

(75) Inventors: Thorsten Bach, Spaichingen (DE); Karsten Lessmann, Rottenburg (DE); Lisa Herrmann, Reutlingen (DE)

(73) Assignee: PFINDER KG, Boeblingen (DE)

(21) Appl. No.: 12/858,951

(22) Filed: Aug. 18, 2010

Related U.S. Application Data
(63) Continuation of application No. PCT/EP2009/001231, filed on Feb. 20, 2009.

(30) Foreign Application Priority Data
Feb. 21, 2008 (DE) 10 2008 011 489.8

(51) Int. Cl. F16J 15/14; F16J 15/02; C08G 18/76

(52) U.S. Cl. 277/316; 277/650; 528/75

(57) ABSTRACT

The invention relates to a method of cavity sealing a motor vehicle component, which comprises the following steps:

a.) spraying of a cavity sealant into the motor vehicle component;

b.) allowing the cavity sealant to penetrate;

c.) allowing excess cavity sealant to drip out from the motor vehicle component; and

d.) curing of the cavity sealant,

whereby the cavity sealant comprises a crosslinkable component. Step a.) is thereby preceded by the step of mixing in a crosslinking component, whereby the amount and type of the crosslinkable component and of the crosslinking component are selected so that the cavity sealant solidifies to a gel-like consistency between step c.) and d.).

### CROSS REFERENCE TO RELATED APPLICATIONS

This application is a continuation of pending international application PCT/EP2009/001231, filed Feb. 20, 2009, designating US, which claims priority from German patent application DE 10 2008 011 489.8, filed Feb. 21, 2008.

### BACKGROUND OF THE INVENTION

The present invention relates to a method for cavity sealing a motor vehicle component, which comprises the following steps:

a.) spraying a cavity sealant into the motor vehicle component; b.) allowing the cavity sealant to penetrate; c.) allowing excess cavity sealant to drip out from the motor vehicle component; and d.) curing the cavity sealant.

The present invention further relates to a composition for producing a cavity sealing, as well as a motor vehicle component having a cavity sealing.

In the production of motor vehicle components, in particular load-bearing components, various structures molded from sheet metal are joined to form larger components. To provide protection against corrosion, these components are coated electrochemically with a surface coating after assembly. In the areas in which two metal parts come to lie close to one another or in which parts of a single metal part are close to each other as a result of bending, a Faraday cage is formed and for this reason no or at least an insufficient amount of the surface coating is deposited. To protect these areas against corrosion by environmental influences, a cavity sealing composed of a cavity sealant is applied there.

A method of producing such a cavity sealing comprises spraying a cavity sealant into the motor vehicle components to be protected, allowing the cavity sealant to penetrate, allowing excess cavity sealant to drip out and curing the cavity sealant in the motor vehicle component to be protected. To ensure sufficient protection, the cavity sealant should always be used in a certain excess. To ensure that the cavity sealant can also penetrate into small cracks and niches in a motor vehicle component, the sealant has to have a high flowability.

After the application of the cavity sealing, it is desirable for the cavity sealant to solidify quickly so that the motor vehicle components can quickly be processed further without cavity sealant dripping out during later processing. Such dripping out of cavity sealant leads during further processing of the motor vehicle components to contamination and, because workers can slip on the sealant, to a safety risk.

However, the solidification of the cavity sealant must not go so far that it impairs the flexibility and plasticity of the cavity sealing necessary to compensate for movements in the components.

A solidification on the basis of a purely oxidative curing of the cavity sealant is not appropriate here because even short curing times in oxidative curing range over a period of several hours, and quick further processing of the motor vehicle components is prevented thereby.

The use of cavity sealants which have been made flowable by the addition of volatile solvents and which solidify as a result of the evaporation of the solvent is nowadays undesirable because of the associated environmental pollution and expenditure for occupational safety as well as possible undesirable effects on the motor vehicle owner due to later evaporation of solvents.

The abovementioned problem has since recently been solved by the use of cavity sealants in which solid so-called dropstop additives have been dispersed in the cavity sealant. These dropstop additives are particles of solid polymers or waxes having a low softening point. Such cavity sealants with dropstop additives can be sprayed into the desired motor vehicle components without problems. After the cavity sealant has dripped out, the motor vehicle components are briefly heated to a temperature of at least 55° C. in a further treatment step. This heating leads to the dropstop additive dispersed in the cavity sealant softening and becoming distributed in the cavity sealant. This results in a gelling of the cavity sealant which consequently solidifies to a gel-like consistency. As a result of this solidification, undesirable dripping-out of cavity sealant can no longer occur during further processing steps.

However, the use of such a cavity sealant with heat-activated drop-stop additives has the disadvantage that in order to heat the motor vehicle components, it is necessary to provide ovens or IR radiators which are large enough to heat even large motor vehicle components to 55° C. and more. This significantly increases the space and energy requirements of this method of cavity sealing. Furthermore, such heating makes the use of these cavity sealants impractical and uneconomical in relatively small units, for example body repair companies.

### SUMMARY OF THE INVENTION

It is therefore an object of the invention to describe a method of cavity sealing a motor vehicle component, by means of which it is possible to achieve a cavity sealing which no longer displays undesirable dripping-out after a short time and which makes do without complicated apparatuses, e.g. for heating motor vehicle components.

A further object of the invention is to describe a composition for producing a cavity sealing for use in this method as well as a motor vehicle component having such a cavity sealing.

According to the invention, the object is achieved by a method for cavity sealing a motor vehicle component, in which the cavity sealant comprises a crosslinkable component and in which step a.) is preceded by the step of mixing in a crosslinking component, whereby the amount and type of the crosslinkable component and of the crosslinking component are selected so that the cavity sealant solidifies to a gel-like consistency between step c.) and d.).

The object is also achieved by a composition for producing a cavity sealing, which comprises a cavity sealant and a solidifying agent, whereby the cavity sealant comprises a crosslinkable component, whereby the solidifying agent comprises a crosslinking component and whereby the amount and type of the crosslinkable component and of the crosslinking component are selected so that the cavity sealant solidifies to a gel-like consistency within a predetermined period of time.

The object is also achieved by a motor vehicle component having a cavity sealing which can be produced by the method of the invention.

It has been found that a crosslinkable component can be mixed into a cavity sealant and can then be crosslinked by the addition of a suitable amount of a crosslinking component so that a gel-like consistency of the cavity sealant which reliably prevents undesirable dripping-out is achieved. The time required for the gel formation in this system is set so that the cavity sealant is sprayed in as a liquid and can penetrate into the cracks and niches to be sealed and can drip out from the motor vehicle components for as long as desired. After this period of time, solidification occurs and reliably prevents further dripping-out. Furthermore, as a result of there being a period of time between spraying-in and gelling in which the cavity sealant remains liquid, a blockage of the spray nozzles by solidified cavity sealant can be avoided.

The addition of the crosslinking component to the cavity sealant can take place directly before spraying-in of the cavity sealant or earlier during the production of the cavity sealant.

In the first case, the corresponding composition for producing the cavity sealing is generally in the form of a 2-component system. However, it is also conceivable for the crosslinking component, to be present in the ambient air, e.g. in the form of atmospheric moisture, so that mixing and spraying-in take place in one step and the composition is present as a 1-component system.

In the second case, the composition for producing a cavity sealing is in the form of a 1-component system and additionally comprises agents for suppressing the reaction between the crosslinkable component and the crosslinking component. These agents for suppressing the reaction are selected so that they are eliminated from the composition (e.g. by evaporation or reactive degradation) shortly before or during the spraying-in and the desired reaction between the crosslinkable component and the crosslinking component thus occurs.

Since the crosslinking reaction which leads to the formation of the gel-like structure proceeds at about room temperature, heating of the motor vehicle component is no longer necessary to solidify the cavity sealant and thus achieve the dropstop effect. The method of the invention thus does not require any large heating apparatuses and such a method can be used in any apparatus designed for the application of a cavity sealing. Furthermore, the method of the invention also works without any large energy input, e.g. for heating the motor vehicle component.

According to the invention, the cavity sealant can be any commercially available cavity sealant which either contains a crosslinkable component from the beginning or into which a crosslinkable component is mixed.

Such cavity sealants usually comprise ingredients such as corrosion inhibitors, such as for example calcium sulfonate, oxidatively crosslinking binders, such as for example alkyd resins, flexibilizers, such as for example mineral oils or esters, fillers, such as for example talc, rheological additives, such as for example inorganic thickeners such as bentonites, organic or inorganic bases which likewise contribute to corrosion protection, such as for example triethylenediamine, catalysts for the oxidative curing of the binder, such as for example manganese salts, and further additives, e.g. to prevent the formation of a skin during standing, such as for example 2-butanone oxime.

As crosslinkable component, any compound or mixture of compounds which can be crosslinked by a reaction with another compound is suitable, as long as they are compatible with the cavity sealant, do not hinder its corrosion-inhibiting effect and do not impair the flexibility and plasticity of the finished cavity sealing.

The crosslinking component can comprise any compound or mixture of compounds which can undergo a crosslinking reaction with the crosslinkable component and does not impair the corrosion-inhibiting effect and the flexibility and plasticity of the cavity sealing.

The precise combination of crosslinkable component and crosslinking component as well as their amounts used can be determined by a person skilled in the art using known methods according to the desired gelling time as well as the degree of solidification and the type of cavity sealant used.

In one embodiment, the crosslinkable component is selected from the group consisting of compounds having active hydrogen atoms, unsaturated polyesters, epoxy resins, moisture-curing prepolymers and mixtures thereof.

The crosslinkable component preferably comprises at least one medium- to long-chain organic compound having at least one functional group selected from the group consisting of amino groups, carboxy groups and hydroxy groups.

Preferred examples of such compounds are alkyd resins, acrylic resins, polyesters, natural and synthetic oils having OH functionality, oxidized waxes and petroleum jellies and hydrocarbon resins having OH functionality.

The abovementioned compounds have the advantage that they are easily modified and can be optimized for use in cavity sealing. They are already widely used today. They give the film formed resistance to heat and mechanical stress. Furthermore, they hold the film together and prevent crack formation on soiling, etc.

In one embodiment of the abovementioned measure, the crosslinkable component comprises castor oil.

Castor oil is a vegetable oil which contains hydroxy groups and is biodegradable and thus advantageous in terms of environmental protection. Furthermore, castor oil is also available in large quantities at acceptable prices, so that its use is also advantageous from an economic point of view.

In a further embodiment, the crosslinking component is selected from the group consisting of amines, peroxides, diisocyanates and mixtures thereof and is preferably selected from the group consisting of diphenylmethane diisocyanate, hexamethylene diisocyanate, toluene diisocyanate, isophorone diisocyanate, trimers or polymers thereof and biuret.

It has been found that these crosslinking components in combinations with the abovementioned crosslinkable components lead to reliable and readily controllable gelling of the cavity sealant.

In a further embodiment, a catalyst which is preferably selected from the group consisting of amines, acids, tin compounds, bismuth compounds, mercury compounds and mixtures thereof is also added.

The addition of a catalyst makes it possible to set the period of time over which the cavity sealant solidifies to a gel-like consistency particularly precisely.

In the case of a composition in the form of a 2-component system, the catalyst can be present either in the cavity sealant or in the solidifying agent or in both components. However, it is also possible to mix the catalyst in as separate component.

In one embodiment of the invention, the crosslinkable component is present in an amount of 5 to 15 parts by weight.

For the purposes of the present invention, amounts given in parts by weight are in each case based on 100 parts by weight of the ready-to-use cavity sealant, i.e. the cavity sealant into which the crosslinking component has already been mixed.

It has been found that the use of the abovementioned amounts makes it possible for reliable gelling to be achieved without excessive curing of the cavity sealant occuring, which would have an adverse effect on the physical properties of the cavity sealing, such as for example the elasticity and plasticity thereof.

In a further embodiment of the invention, the crosslinking component is present in an amount of 0.1 to 10 parts by weight.

It has been found that when these amounts of the crosslinking component are used, reliable gelling can be achieved without the later physical properties of the cavity sealing, such as for example the flexibility and plasticity thereof, being adversely affected. It has also been found that the use of these amounts of crosslinking component lead to a period of time up to the formation of the gel-like consistency which is long enough for problem-free spraying-in and reliable penetration of the cavity sealant to be achieved but at the same time makes quick further processing of the motor vehicle component possible.

In a further embodiment of the invention, the mixture of the cavity sealant and the crosslinking component before spraying-in has a viscosity of less than 500 mPa·s and in particular less than 200 mPa·s, in each case at a shear rate of 760 s₋₁ and 23° C.

The abovementioned viscosities are measured in accordance with DIN 53018. It has been found that mixtures having the viscosities mentioned can readily be sprayed into motor vehicle components and have a sufficient flowability to penetrate rapidly into even small cracks and niches.

In a further embodiment, the composition is formulated so that the period of time within which the cavity sealant solidifies to a gel-like consistency is from 15 to 45 minutes.

The choice of such a period of time firstly leaves a sufficient time for the cavity sealant to be able to be sprayed without problems into a motor vehicle component and to penetrate into the desired cavities and secondly ensures a quick subsequent further processing of the motor vehicle component.

It goes without saying that the features mentioned above and those still to be explained below can be employed not only in the combination indicated in each case but also in other combinations or on their own without leaving the scope of the present invention.

### BRIEF DESCRIPTION OF THE DRAWINGS

The invention will now be illustrated with the aid of examples and the accompanying drawings. In the drawings:

FIG. 1 shows a graph in which the development of the viscosity of a composition as per Example 1 is plotted against time, and

FIG. 2 shows a motor vehicle component which is provided with a cavity sealing at three different points in time during the cavity sealing, namely t₁=0, t₂=5 and t₃=20 minutes.

### DETAILED DESCRIPTION OF PREFERRED EMBODIMENTS

### EXAMPLE 1

A first composition for producing a cavity sealing comprises, as first component, a cavity sealant according to the formulation shown in Table 1. The ingredient designated as base mixture is a cavity sealant which is commercially available under catalog No. 0090 0500 from Pfinder Chemie, Boblingen, Germany.

In this first component, the castor oil forms the crosslinkable component. The triethylenediamine acts as catalyst for the reaction of the crosslinkable component with the crosslinking component.

The amounts indicated are in parts by weight based on 100 parts of the finished cavity sealant, i.e. including the crosslinking component.

TABLE 1

| Ingredient | Amount |
|---|---|
| Base mixture | 81 |
| Castor oil | 13 |
| Triethylenediamine | 1 |

The second component comprising the crosslinking component, i.e. the solidifying agent of the composition, comprises diphenylmethane diisocyanate or a polymer thereof in an amount which after mixing with the cavity sealant corresponds to five parts by weight.

The mixture of the first component and the second component directly after mixing has a viscosity of 150 ±20 mPa·s at a shear rate of 760 s⁻¹ and 23° C. measured in accordance with DIN 53018. Thirty minutes after mixing, the composition has solidified to a gel having a viscosity of about 35×10³ Pa·s at a shear stress of 1 Pa and 23° C. measured in accordance with DIN 53018.

Thus, a cavity sealant which can initially be readily sprayed in and can also penetrate into small cracks and niches and which solidifies after a defined period of time to form a gel which no longer runs out can thus be produced from the first and second component of Example 1.

### EXAMPLE 2

A second composition for producing a cavity sealing comprises, as first component, a cavity sealant according to the formulation shown in Table 2. The ingredient designated as base mixture is a cavity sealant which is commercially available under catalog number 0090 0600 from Pfinder Chemie, Boblingen, Germany.

In this first component, the castor oil once again forms the crosslinkable component. The triethylenediamine acts as catalyst for the reaction of the crosslinkable component with the crosslinking component.

The amounts indicated are once again in parts by weight based on 100 parts of the finished cavity sealant, i.e. including the crosslinking component.

TABLE 2

| Ingredient | Amount |
|---|---|
| Base mixture | 56 |
| Castor oil | 13 |
| Triethylenediamine | 1 |

The second component comprising the crosslinking component, i.e. the solidifying agent of the composition, has the composition shown in Table 3.

TABLE 3

| Ingredient | Amount |
|---|---|
| Paraffinic mineral oil | 23.4 |
| Diphenylmethane diisocyanate polymer | 5.1 |
| Pentaerythrityl tetrastearate | 1.5 |

In this second component, the diphenylmethane diisocyanate polymer forms the crosslinking component. The paraffinic mineral oil is a commercially available paraffinic mineral oil having a viscosity at 40° C. of from 12.5 to 15.5 mm² per second (measured in accordance with DIN 51562-1), which here acts as diluent for the crosslinking component. The pentaerythrityl tetrastearate here serves as stabilizer in order to stabilize the suspension of the diphenylmethane diisocyanate polymer in the mineral oil.

The mixture of the first component and the second component directly after mixing has a viscosity of 150 ±30 mPa·s at a shear rate of 760 s₋₁ and 23° C. measured in accordance with DIN 53018. Thirty minutes after mixing, the composition has solidified to a gel having a viscosity of about 35×10³ Pa·s at a shear stress of 1 Pa and 23° C. measured in accordance with DIN 53018.

Thus, a cavity sealant which can initially be readily sprayed in and can also penetrate into small cracks and niches and which solidifies after a defined period of time to form a gel which no longer runs out can thus be produced from the first and second component of Example 2.

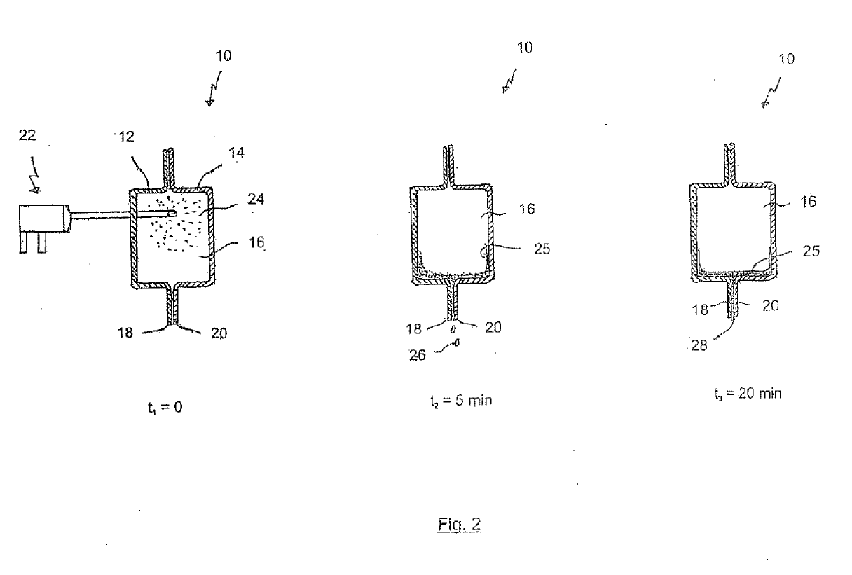

In the method of producing a cavity sealing as shown in FIG. 2, a cavity sealant having the composition shown in Table 1 is mixed in a suitable mixing chamber with the solidifying agent of Example 1 in a first step. The mixture formed is sprayed by means of a spray gun 22 known to those skilled in the art for applying cavity sealant, e.g. manually or using robots or a nozzle frame, into a vehicle component 10, with the sprayed-in mixture being used in a slight excess. The vehicle component 10 depicted is a door spar made up of two shaped components 12 and 14, e.g. joined by point welding.

In the next step, the mixture which has been sprayed in is allowed to penetrate into cracks and niches of the motor vehicle component, during which the motor vehicle component may be moved in order to ensure a complete penetration of the hollow space preservative. Such a crack exists between the two joined parts 18 and 20. Here, wax 24 drips out from the motor vehicle component 10 in the form of droplets 26.

From the point in time at which the two components are mixed, a crosslinking reaction between the diphenylmethane diisocyanate of the solidifying agent and the castor oil present in the cavity sealant according to the reaction scheme 1 shown below commences in the composition. This process leads to the gelling of the cavity sealant and prevents later undesired dripping-out of the cavity sealing wax. A layer 25 of cavity sealant 24 is thus formed in the interior space 16.

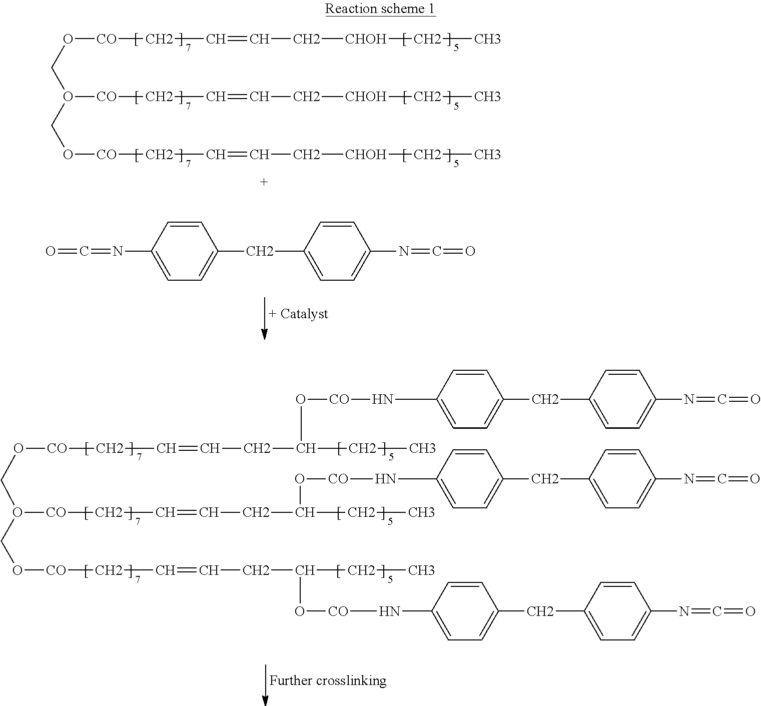

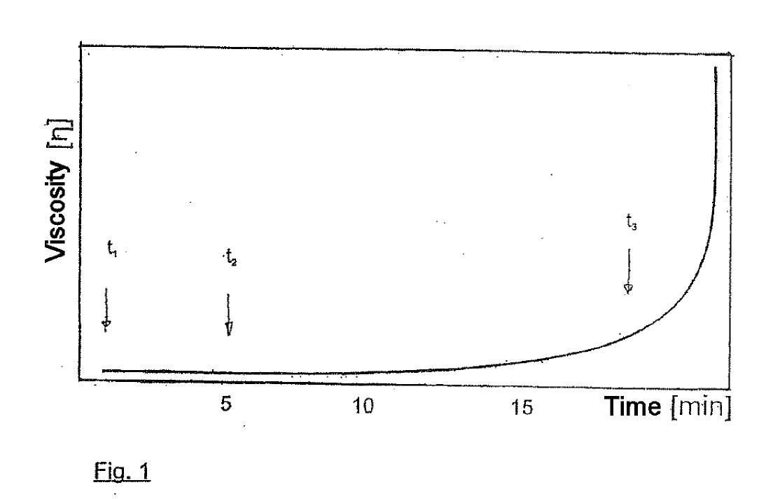

The development of the viscosity of a composition according to Example 1 is shown here in FIG. 1. The profile of the reaction between the crosslinkable component (castor oil) and the crosslinking component (diphenylmethane diisocyanate) is such that the preparation has a flowability for the first 15 minutes, which is only slightly different from that of known cavity sealant preparations. After this time, a rapidly progressing gelling of the cavity sealant commences, so that after about 30 minutes a consistency at which dripping-out can no longer occur is reached. Full curing of the cavity sealing 28 then occurs by an oxidative curing during the further processing of the motor vehicle component 10 over the next hours.

1. A method of cavity sealing a motor vehicle component, which comprises the following steps:
a.) spraying of a cavity sealant into said motor vehicle component;
b.) allowing said cavity sealant to penetrate;
c.) allowing excess cavity sealant to drip out from said motor vehicle component; and
d.) curing of said cavity sealant;
whereby said cavity sealant comprises a crosslinkable component and whereby step a.) is preceded by a step of mixing in a crosslinking component, whereby an amount and type of said crosslinkable component and of said crosslinking component are selected so that said cavity sealant solidifies to a gel-like consistency between step c.) and d.).

2. The method of claim 1, whereby said crosslinkable component is selected from the group consisting of compounds having active hydrogen atoms, unsaturated polyesters, epoxy resins, moisture-curing prepolymers and mixtures thereof.

3. The method of claim 2, whereby said crosslinkable component comprises at least one medium- to long-chain organic compound having at least one functional group selected from the group consisting of amino groups, carboxy groups and hydroxy groups.

4. The method of claim 3, whereby said crosslinkable component comprises castor oil.

5. The method of claim 1, whereby said crosslinking component is selected from the group consisting of amines, peroxides, isocyanates and mixtures thereof.

6. The method of claim 5, whereby said crosslinking component is selected from the group consisting of diphenylmethane diisocyanate, hexamethylene diisocyanate, toluene diisocyanate, isophorone diisocyanate, trimers or polymers thereof and biuret.

7. The method according of claim 1, further comprising the addition of a catalyst.

8. The method of claim 7, whereby said catalyst is selected from the group consisting of amines, acids, tin compounds, bismuth compounds, mercury compounds and mixtures thereof.

9. The method of claim 1, whereby said crosslinkable component is present in an amount of 5 to 15 parts by weight.

10. The method of claim 1, whereby said crosslinking component is present in an amount of 0.1 to 10 parts by weight.

11. The method of claim 1, whereby a mixture of said cavity sealant and said crosslinking component has a viscosity of less than 500 mPa·s at a shear rate of 760 s⁻¹ and 23° C. before said spraying-in in step a).

12. The method of claim 11, whereby said mixture of said cavity sealant and said crosslinking component has a viscosity of less than 200 mPa·s at a shear rate of 760 s⁻¹ and 23° C. before the spraying-in in step a).

13. Composition for producing a cavity sealing, which comprises a cavity sealant and a solidifying agent, whereby said cavity sealant comprises a crosslinkable component, whereby said solidifying agent comprises a crosslinking component and whereby an amount and type of said crosslinkable component and of said crosslinking component are selected so that said cavity sealant solidifies to a gel-like consistency within a predetermined period of time.

14. The composition of claim 13, whereby said crosslinkable component is selected from the group consisting of compounds having active hydrogen atoms, unsaturated polyesters, epoxy resins, moisture-curing prepolymers and mixtures thereof.

15. The composition of claim 14, whereby said crosslinkable component comprises at least one medium- to long-chain organic compound having at least one functional group selected from the group consisting of amino groups, carboxy groups and hydroxy groups.

16. The composition of claim 15, whereby said crosslinkable component comprises castor oil.

17. The composition of claim 13, whereby said crosslinking component is selected from the group consisting of amines, peroxides, isocyanates and mixtures thereof.

18. The composition of claim 17, whereby said crosslinking component is selected from the group consisting of diphenylmethane diisocyanate, hexamethylene diisocyanate, toluene diisocyanate, isophorone diisocyanate, trimers or polymers thereof and biuret.

19. The composition of claim 13 further comprising a catalyst.

20. The composition of claim 19, whereby said catalyst is selected from the group consisting of amines, acids, tin compounds, bismuth compounds, mercury compounds and mixtures thereof.

21. The composition of claim 13, whereby said crosslinkable component is present in an amount of 5 to 15 parts by weight.

22. The composition of claim 13, whereby said crosslinking component is present in an amount of 0.1 to 10 parts by weight.

23. The composition of claim 13, whereby a mixture of said cavity sealant and said crosslinking component has a viscosity of less than 500 mPa·s at a shear rate of 760 s⁻¹ and 23° C. before solidification.

24. The composition of claim 23, whereby said mixture of said cavity sealant and said crosslinking component has a viscosity of less than 200 mPa·s at a shear rate of 760 s⁻¹ and 23° C. before solidification.

25. The composition of claim 13, wherein a period of time within which said cavity sealant solidifies to a gel-like consistency is from 15 to 45 minutes.

26. Motor vehicle component comprising a cavity sealing which can be produced by the method of claim 1.
